(19) United States
(12) Patent Application Publication
(10) Pub. No.: US 2022/0377502 A1
(43) Pub. Date: Nov. 24, 2022

(54) CONTROL DEVICE, NON-TRANSITORY COMPUTER READABLE STORAGE MEDIUM, AND SYSTEM

(71) Applicant: KABUSHIKI KAISHA TOKAI RIKA DENKI SEISAKUSHO, Aichi (JP)

(72) Inventors: Yosuke OHASHI, Aichi (JP); Yosuke HASEGAWA, Aichi (JP)

(73) Assignee: KABUSHIKI KAISHA TOKAI RIKA DENKI SEISAKUSHO, Aichi (JP)

(21) Appl. No.: 17/716,549

(22) Filed: Apr. 8, 2022

(30) Foreign Application Priority Data
May 21, 2021 (JP) 2021-086070

(51) Int. Cl. H04W 4/029; H04W 4/38; H04W 76/15; H04W 64/00

(52) U.S. Cl. CPC H04W 4/029; H04W 4/38; H04W 76/15; H04W 64/003

(57) ABSTRACT

There is provided a control device provided in a housing, the control device comprising: a control unit configured to control distance measurement based on a wireless signal conforming to a predetermined communication standard that is transmitted and received between at least one first communication device provided in the same housing and a portable device, wherein the control unit activates the first communication device when presence of the portable device around the housing has been detected.

### CROSS REFERENCE TO RELATED APPLICATION(S)

This application is based upon and claims benefit of priority from Japanese Patent Application No. 2021-086070, filed on May 21, 2021, the entire contents of which are incorporated herein by reference.

### BACKGROUND

The present invention relates to a control device, a non-transitory computer readable storage medium, and a system.

Recently, there has been developed a technology of performing processing based on wireless signals transmitted and received between devices. For example, Japanese Patent Application Laid-open No. 2020-118030 discloses a technology of measuring a distance between devices using ultra wide band (UWB) signals.

### SUMMARY

In general, the wireless signal used for the above-described distance measurement has relatively large power consumption associated with a reception standby state.

In view of the above-described problem, the present invention aims at effectively reducing power consumption associated with the reception of wireless signals used for measuring a distance.

To solve the above described problem, according to an aspect of the present invention, there is provided a control device provided in a housing, the control device comprising: a control unit configured to control distance measurement based on a wireless signal conforming to a predetermined communication standard that is transmitted and received between at least one first communication device provided in the same housing and a portable device, wherein the control unit activates the first communication device when presence of the portable device around the housing has been detected.

To solve the above described problem, according to another aspect of the present invention, there is provided a non-transitory computer readable storage medium storing a program, the program controlling a computer to function as a control device that is provided in a housing; controlling the control device to achieve a control function for controlling distance measurement based on a wireless signal conforming to a predetermined communication standard that is transmitted and received between at least one first communication device provided in the same housing and a portable device; and controlling the control function to activate the first communication device when presence of the portable device around the housing has been detected.

To solve the above described problem, according to another aspect of the present invention, there is provided a system, comprising: a control device that is provided in a housing; and at least one first communication device that is provided in the same housing, wherein the control device controls distance measurement based on a wireless signal conforming to a predetermined communication standard that is transmitted to and received from a portable device, and activates the first communication device when presence of the portable device around the housing has been detected.

As described above, in the present invention, it is possible to effectively reduce power consumption associated with the reception of wireless signals used for measuring a distance.

### BRIEF DESCRIPTION OF THE DRAWINGS

FIG. 1 is a block diagram illustrating a configuration example of a system 1 according to an embodiment of the present invention.

FIG. 2 is a sequence diagram illustrating an example of a flow of processing by the system 1 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

1.1. System Configuration Example

First, a configuration example of the system 1 according to an embodiment of the present invention will be described.

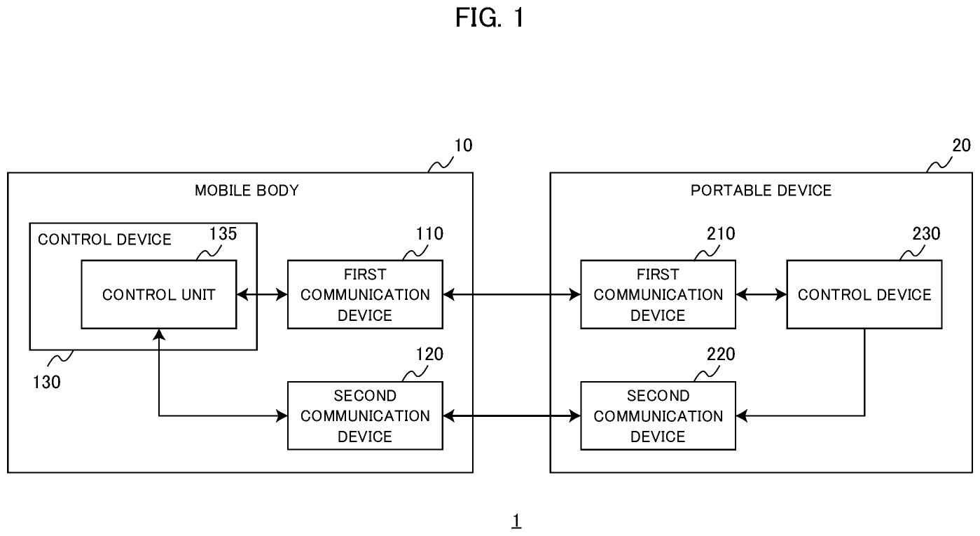

FIG. 1 is a block diagram illustrating a configuration example of the system 1 according to an embodiment of the present invention.

As illustrated in FIG. 1, the system 1 of the embodiment may include a plurality of devices provided in a mobile body 10 and a portable device.

Mobile Body 10

The mobile body 10 of the embodiment is an example of the housing.

The mobile body 10 may be, for example, a vehicle, a ship, an airplane, or the like.

As illustrated in FIG. 1, the mobile body 10 may be provided with a first communication device 110, a second communication device 120, a control device 130, and the like.

First Communication Device 110

The first communication device 110 of the embodiment performs transmission and reception of wireless signals conforming to the first communication standard (also referred to as the predetermined communication standard in the present disclosure) with a first communication device 210 provided in a portable device 20.

For this purpose, the first communication device 110 of the present embodiment includes an antenna for transmitting and receiving wireless signals conforming to the first communication standard.

As the first communication standard of the embodiment, ultra wide band wireless communication, for example, may be adopted.

However, the first communication standard of the embodiment is not limited to the ultra wide band wireless communication. The first communication standard of the embodiment may be various kinds of communication standards for transmitting and receiving wireless signals useful to estimate the positional relationship between communication devices.

In cooperation with the first communication device 210 provided in the portable device 20, the first communication device 110 of the embodiment performs distance measurement for estimating a distance to the first communication device 210 on the basis of wireless signals conforming to the first communication standard that are transmitted to and received from the first communication device 210.

Note that a plurality of first communication devices 110 of the embodiment may be provided for one mobile body 10.

In this case, each of the first communication devices 110 provided in the mobile body 10 may measure a distance to the first communication device 210 provided in the portable device 20.

Second Communication Device 120

The second communication device 120 of the embodiment performs transmission and reception of wireless signals conforming to the second communication standard (also referred to as another communication standard in the present disclosure) different from the first communication standard with a second communication device 220 provided in the portable device 20.

For this purpose, the second communication device 120 of the embodiment includes an antenna for transmitting and receiving wireless signals conforming to the second communication standard.

Here, the wireless signal conforming to the predetermined communication standard of the embodiment is characterized in having lager power consumption associated with the standby state for receiving the wireless signal than the wireless signal conforming to the second communication standard.

Thus, Bluetooth (Registered Trademark) Low Energy (BLE), for example, may be adopted as the second communication standard of the embodiment.

However, BLE is merely an example, and various standards satisfying the above-described characteristics related to power consumption may be adopted for the second communication standard of the embodiment.

Control Device 130

The control device 130 of the embodiment controls wireless communication performed by each of the first communication device 110 and the second communication device 120 provided in the same mobile body 10.

The control device 130 of the embodiment includes a control unit 135 that controls distance measurement based on wireless signals conforming to the first communication standard that are transmitted and received between at least one first communication device 110 provided in the same mobile body 10 and the first communication device 210 provided in the portable device 20.

The control unit 135 of the embodiment may be characterized in activating the first communication device 110 when the presence of the portable device 20 around the mobile body 10 has been detected.

With such characteristics of the control unit 135, when no portable device 20 is present around the mobile body 10, it is possible to prevent the first communication device 110 from receiving or transmitting unnecessary wireless signals, and effectively reduce power consumption.

Further, the control unit 135 of the embodiment may control the operation of various controlled devices (omitted in the drawing) provided in the mobile body 10 on the basis of the result of distance measurement based on wireless signals conforming to the first communication standard, or the like.

For example, when the authenticity of the portable device 20 is verified in the authentication using wireless signals and the result of distance measurement is within a predetermined range (that is, the portable device 20 is considered to be positioned within the predetermined range from the mobile body 10), the control unit 135 of the embodiment may control the controlled devices to perform predetermined operation.

Examples of the controlled device according to the embodiment include a locking device for controlling locking and unlocking of the doors of the mobile body 10, an engine, and the like.

For example, when the authenticity of the portable device 20 is verified in the authentication and the measured distance value that is a result of distance measurement is equal to or smaller than a predetermined value, the control unit 135 may instruct the locking device to perform unlocking.

For example, when the authenticity of the portable device 20 is verified in the authentication and the measured distance value is equal to or smaller than a predetermined value, the control unit 135 may permit the engine to start.

The functions of the control unit 135 of the embodiment are achieved by various processors.

The details of the functions of the control unit 135 of the embodiment will be described later.

Portable Device 20

The portable device 20 of the embodiment is carried by a user using the mobile body 10 (the owner of the mobile body 10, or a person authorized to use the mobile body 10 by the owner, for example).

The portable device 20 of the embodiment may be, for example, a smartphone, a wearable device, or a dedicated device designed for use in the system 1.

As illustrated in FIG. 1, the portable device 20 of the embodiment may include the first communication device 210, the second communication device 220, and a control device 230.

First Communication Device 210

The first communication device 210 of the embodiment performs transmission and reception of wireless signals conforming to the first communication standard with the first communication device 110 provided in the mobile body 10.

For this purpose, the first communication device 210 of the embodiment includes an antenna for transmitting and receiving wireless signals conforming to the first communication standard.

Second Communication Device 220

The second communication device 220 of the embodiment performs transmission and reception of wireless signals conforming to the second communication standard (also referred to as another communication standard in the present disclosure) with the second communication device 120 provided in the mobile body 10.

For this purpose, the second communication device 220 of the embodiment includes an antenna for transmitting and receiving wireless signals conforming to the second communication standard.

Control Device 230

The control device 230 of the embodiment controls wireless communication performed by each of the first communication device 210 and the second communication device 220 provided in the same portable device 20.

The functions of the control device 230 of the embodiment are achieved by various processors.

The above has described the configuration example of the system 1 according to the embodiment. Note that the configuration described above using FIG. 1 is merely an example and the configuration of the system 1 of the embodiment is not limited thereto.

The configuration of the system 1 of the embodiment can be modified flexibly depending on specifications and uses.

1.2. Details of Control

The following will specifically describe the control by the control device 130 provided in the mobile body 10 according to the embodiment.

As described above, wireless signals suitable for distance measurement is characterized in having relatively large power consumption associated with a reception standby state.

Thus, if the first communication device 110 is constantly in the standby state for receiving wireless signals for distance measurement, the power consumption is increased, which may cause the battery in the mobile body 10 for providing power to the first communication device 110 to go dead.

In order to avoid such a situation, it is required not to perform the above-described reception standby when the execution of distance measurement is not possible.

Thus, the control unit 130 of the embodiment may activate the first communication device 110 when the presence of the portable device 20 around the mobile body 10 has been detected.

As an example, the control device 130 of the embodiment may detect the presence of the portable device 20 around the mobile body 10 on the basis of wireless signals conforming to the second communication standard that are transmitted from the portable device 20.

With such a control, it is possible to effectively reduce power consumption associated with the reception of wireless signals used for measuring a distance.

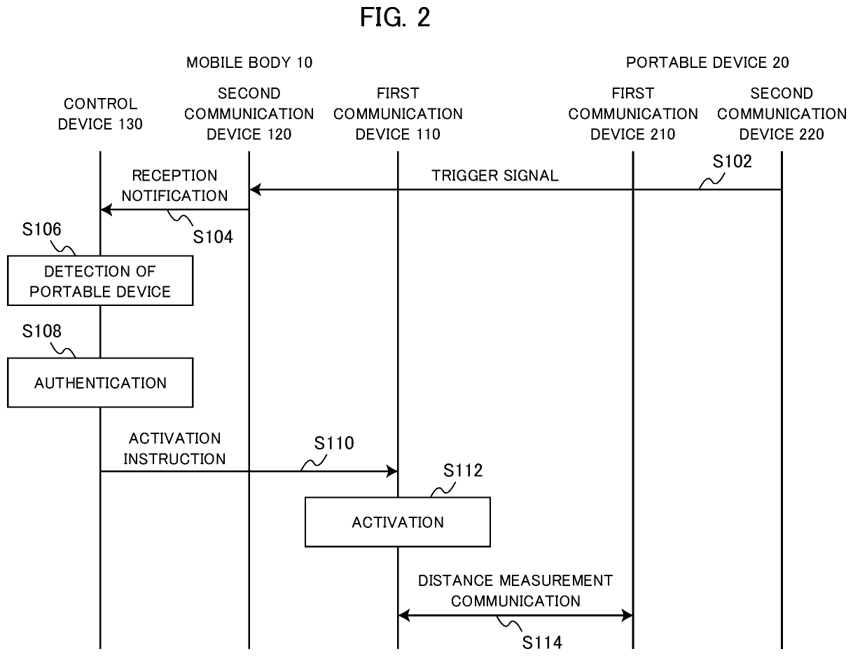

The following will specifically describe the control by the control device 130 according to the embodiment, with reference to FIG. 2.

FIG. 2 is a sequence diagram illustrating an example of a flow of processing by the system 1 according to the embodiment.

In the case of an example illustrated in FIG. 2, the second communication device 220 provided in the portable device 20 first transmits a trigger signal conforming to the second communication standard, in accordance with the control by the control device 230 (omitted in the drawing) (S102).

Here, the above-described trigger signal may be various wireless signals that can be a trigger for starting the control of activating the first communication device 110 by the control device 130 provided in the mobile body 10.

For example, in a case where BLE is adopted for the second communication standard, the above-described trigger signal can be a wireless signal such as an advertisement and a connection request.

Upon receiving the trigger signal at Step S102, the second communication device 120 provided in the mobile body 10 transmits a reception notification indicating that the trigger signal has been received to the control device 130 (S104).

The reception notification may include the contents of the trigger signal.

As an example, the second communication device 120 may transmit information generated by digitally converting a received trigger signal to the control device 130.

Next, the control device 130 detects the presence of the portable device 20 around the mobile body 10 on the basis of the reception of the reception notification at Step S104 (S106).

That is, when the second communication device 120 has received a wireless signal conforming to the second communication standard that is transmitted from the portable device 20, the control device 130 of the embodiment is able to detect the presence of the portable device 20 within an area allowing wireless communication conforming to the second communication standard with the mobile body 10 as a reference.

Meanwhile, the control device 130 of the embodiment may detect the presence of the portable device 20 when wireless communication conforming to the second communication standard has been established between the second communication device 120 and the second communication device 220.

In this case, the control device 130 controls, for example, the second communication device 120 to transmit a connection response in response to the received connection request, and detects the presence of the portable device 20 when the connection has been established between the second communication device 120 and the second communication device 220.

Further, the control device 130 of the embodiment may authenticate the portable device 20 on the basis of, for example, wireless signals conforming to the second communication standard that are transmitted and received between the second communication device 120 and the second communication device 220 (S108).

As an example, if the trigger signal received by the second communication device 120 at Step S102 contains information proving the authenticity of the portable device 20 (an ID, a password, or the like, for example), the control device 130 may authenticate the portable device 20 on the basis of such information.

Meanwhile, the control device 130 may control the second communication device 120 to transmit a wireless signal (a request signal) for requesting information proving the authenticity of the portable device 20, and authenticate the portable device 20 on the basis of the information contained in a wireless signal (a response signal) received by the second communication device 120 in response to the request signal.

Note that the above is merely an example, and various authentication methods may be adopted for the authentication according to the embodiment. The wireless signals required to achieve an adopted authentication method may be transmitted and received between the second communication device 120 and the second communication device 220.

When the authenticity of the portable device 20 is verified in the authentication at Step S108, the control device 130 transmits an activation instruction to the first communication device 110 (S110).

The first communication device 110 is activated in accordance with the activation instruction received at Step S110 (S112).

Thereafter, transmission and reception of wireless signals used for measuring a distance (distance measurement communication) are performed between the first communication device 110 provided in the mobile body 10 and the first communication device 210 provided in the portable device 20 (S114).

Note that the operation of the first communication device 110 after the activation at Step S112 may be determined in accordance with a sequence of distance measurement.

For example, in a case where the first communication device 210 provided in the portable device 20 transmits the first signal in distance measurement communication, the first communication device 110 provided in the mobile body 10 may shift to the standby state for receiving such a first signal.

Meanwhile, the first communication device 110 provided in the mobile body 10 may transmit the first signal after the activation at Step S112.

In any of the above cases, the first communication device 110 is activated when distance measurement communication is possible. Thus, it is possible to prevent an increase of power consumption.

The above has described the flow of the operation by the system 1 according to the embodiment.

Note that the flow described above using FIG. 2 is merely an example and the flow of the operation by the system 1 according to the embodiment is not limited thereto.

For example, the above has exemplified the case in which the control device 130 detects the presence of the portable device 20 on the basis of wireless communication conforming to the second communication standard.

However, the control device 130 of the embodiment may detect the presence of the portable device 20 or the presence of a user who may carry the portable device 20, on the basis of an image captured by a camera provided in the mobile body 10, for example.

Moreover, the authentication of the embodiment is not limited to the authentication method using wireless signals conforming to the second communication standard. The authentication according to the embodiment may be substituted by a method such as biometrics authentication, for example, and may not necessarily be performed prior to distance measurement.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

Moreover, a sequence of processing by the devices described in the present specification may be achieved by a program stored in a non-transitory computer readable storage medium. Each program is read in a random access memory (RAM) when executed by a computer, and executed by a processor such as a central processing unit (CPU). The above-described storage medium is, for example, a magnetic disk, an optical disk, a magneto-optical disk, a flash memory, or the like. Moreover, the above-described program may be distributed through a network, for example, without using any storage medium.

What is claimed is:

1. A control device provided in a housing, the control device comprising:
a control unit configured to control distance measurement based on a wireless signal conforming to a predetermined communication standard that is transmitted and received between at least one first communication device provided in the same housing and a portable device, wherein
the control unit activates the first communication device when presence of the portable device around the housing has been detected.

2. The control device according to claim 1, wherein the control unit detects the presence of the portable device around the housing, on the basis of a wireless signal conforming to another communication standard different from the predetermined communication standard that is transmitted from the portable device.

3. The control device according to claim 2, wherein the control unit activates the first communication device when a second communication device that is a device different from the first communication device and provided in the same housing has received the wireless signal conforming to the another communication standard that is transmitted from the portable device.

4. The control device according to claim 2, wherein the control unit activates the first communication device when wireless communication conforming to the another communication standard has been established between a second communication device that is a device different from the first communication device and provided in the same housing and the portable device.

5. The control device according to claim 2, wherein the wireless signal conforming to the predetermined communication standard has larger power consumption associated with a standby state for receiving the wireless signal than the wireless signal conforming to the another communication standard.

6. The control device according to claim 1, wherein the predetermined communication standard includes ultra wide band wireless communication.

7. The control device according to claim 2, wherein the another communication standard includes BLE.

8. The control device according to claim 1, wherein the housing includes a mobile body.

9. A non-transitory computer readable storage medium storing a program, the program
controlling a computer to function as a control device that is provided in a housing;
controlling the control device to achieve a control function for controlling distance measurement based on a wireless signal conforming to a predetermined communication standard that is transmitted and received between at least one first communication device provided in the same housing and a portable device; and
controlling the control function to activate the first communication device when presence of the portable device around the housing has been detected.

10. A system, comprising:
a control device that is provided in a housing; and
at least one first communication device that is provided in the same housing,
wherein
the control device controls distance measurement based on a wireless signal conforming to a predetermined communication standard that is transmitted to and received from a portable device, and activates the first communication device when presence of the portable device around the housing has been detected.
